(19) United States
(12) Patent Application Publication
(10) Pub. No.: US 2005/0184162 A1
(43) Pub. Date: Aug. 25, 2005

(54) Holding and display device

(76) Inventor: Graham G. Bubb, Aptos, CA (US)

Correspondence Address: JEFFREY HALL, 212 CLINTON ST, SANTA CRUZ, CA, 95062, US

(21) Appl. No.: 10/785,762

(22) Filed: Feb. 24, 2004

(51) Int. Cl. G06K 7/00

(52) U.S. Cl. 235/486

(57) ABSTRACT

A device for holding, magnifying, and displaying credit cards, debit cards, and other articles, comprising a lens element and a base. The lens element has one or more receiving slots for holding, securing, and displaying credit cards, debit cards, receipts, or other articles therein. The lens element is secured in the base. The base has a receiving aperture for receiving and securing the lens element therein.

### BACKGROUND OF THE INVENTION

1. Technical Field

This invention relates to display devices for cards such as credit or debit cards, and other articles, and for displaying and magnifying such cards and articles in a convenient and utilitarian manner.

2. Background Art

Various display devices have been proposed and implemented for holding and displaying cards, papers and other articles. Although prior devices have been adapted and used for various purposes, there exists a need for a holding and display device for cards, such as credit cards and debit cards which may be used conveniently and reliably in bars, restaurants, and other locations.

Accordingly, the primary object of the present invention is to provide a device for holding and displaying a card, such as a credit card or a debit card, paper receipt or the like, in a manner which so that it is easy and convenient to locate a particular card or receipt or the like, and to organize and display the same. The item to be displayed may be any type of article such as a credit card, debit card, business card, check, receipt, or the like. The present invention may be provided in a variety of sizes and configurations, and is made of a durable resilient material such as polystyrene, plastic, thermoplastic, metal, wood, or other durable resilient material.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims.

### BRIEF SUMMARY OF THE INVENTION

To achieve the foregoing objects, and in accordance with the purpose of the invention as embodied and broadly described herein, a device for holding and displaying credit cards, debit cards, and other articles is provided, comprising a lens element and a base. The lens element has one or more receiving slots for holding, securing, and displaying credit cards, debit cards, or other articles therein. The lens element is secured in the base. The base has a receiving aperture for receiving and securing the lens element therein. Illumination means may be provided for illuminating the lens and the cards or other articles held in the device.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is a isometric view of a holding and display device, according to the invention.

FIG. 2 shows a lens element removed from the base of such a device, according to the invention.

FIG. 3 shows such a top view of the lens element removed from the base of such device, according to the invention.

FIG. 4 is a rear isometric view of such holding and display device, according to the invention.

FIG. 5 shows an embodiment of such a holding and display device having illumination means and switch, according to the invention.

### DETAILED DESCRIPTION OF THE INVENTION

Reference will now be made in detail to the present preferred embodiments of the invention as illustrated in the accompanying drawings.

In accordance with the present invention, there is provided in a preferred embodiment of the invention, a device for holding, magnifying, and displaying credit cards, debit cards, and other articles, comprising a lens element and a base. The lens element has one or more receiving slots for holding, securing, and displaying credit cards, debit cards, hotel room cards, or other articles therein. The lens element is secured in the base. The base has a receiving aperture for receiving and securing the lens element therein. Illumination means, which may be a light bulb, fiber optic, LED or the like, may be provided for illuminating the lens and cards or other articles held in the device.

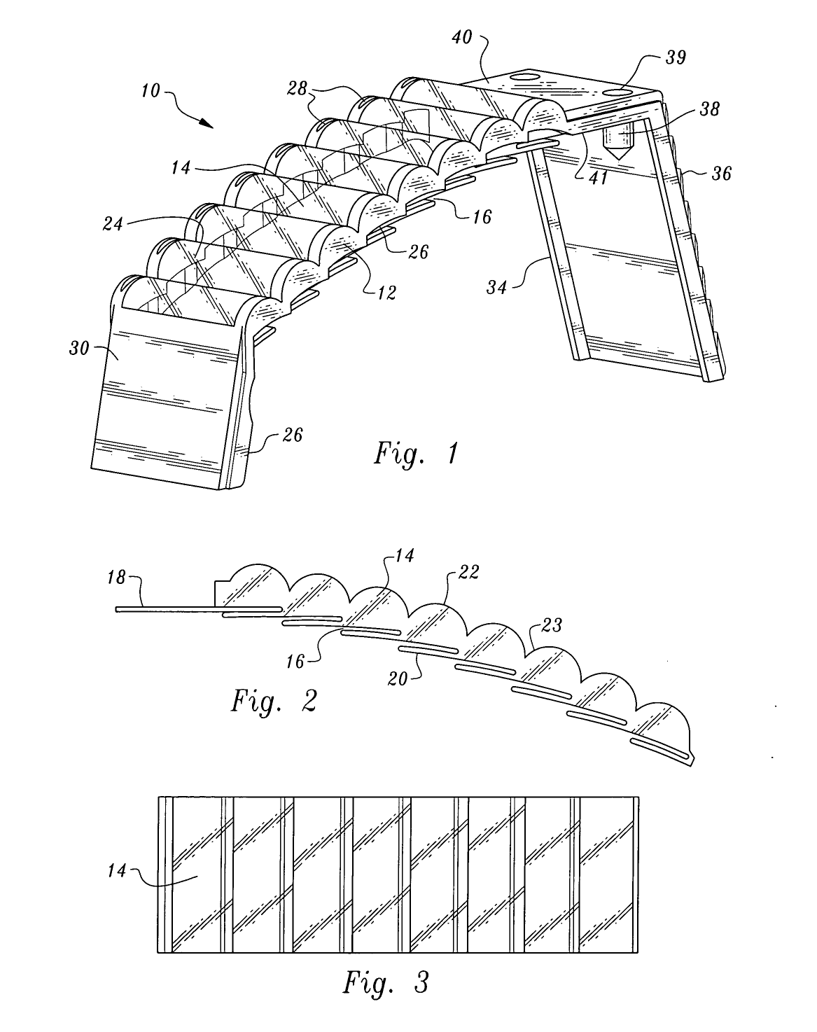

In FIG. 1, a preferred embodiment of holding and display device 10, is shown. Preferably, device 10, includes a base element 12, and a lens element 14. The lens element 14, has one or more receiving slots 16, best seen in FIG. 2, for holding, securing, and displaying credit cards 18, debit cards, or other articles.

Best seen in FIG. 2, lens element 14, may be curved or flat, and has a bottom surface 20, with receiving slots 16, for holding credit cards, debit cards or the like, for magnification and ease of viewing. Top surface 22 which may be curved 23, have multiple curves with each corresponding to a receiving slot 16, or be flat, is configured for easy and convenient viewing of credit cards, debit cards or other articles held in receiving slots 16. Lens element 14, may be one or more lens, and is composed of plastic, glass, or other visually magnifying material.

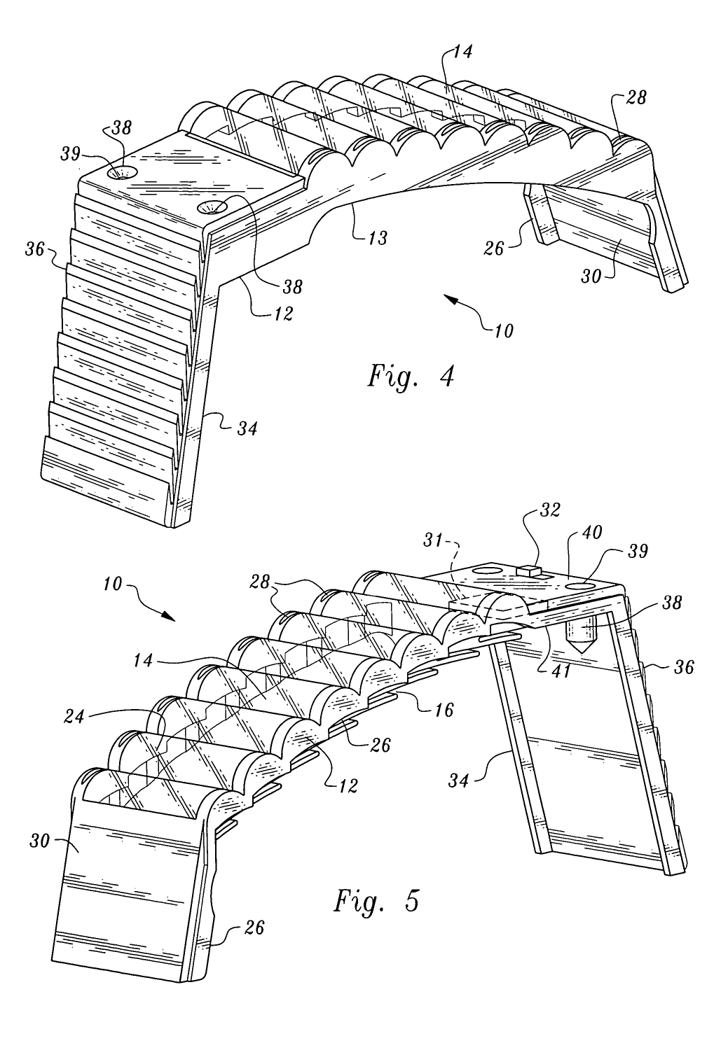

As seen in FIGS. 1 and 4, base 12 may be provided in a rectangular configuration as shown, or provided in other geometric configurations, such as square, oval, round or the like. Base 12, is preferably configured having a receiving aperture 24, for receiving and securing lens element 14, therein. Lens element 14, may be fitted to “snap” into receiving aperture 24, and/or other fastening means may be used such as adhesives, retaining notches, support shelves or the like.

Base 12, preferably is configured with a front leg 26, which may include a plurality of holes 28, for holding receipts, or other items. Holes 28, preferably are holes running through base 12, in line with each lens curve. Best seen in FIGS. 1 and 5, front leg 26, preferably has a front leg support 30. Illumination means, such a light bulb 31, and switch 32, secured to light 31, maybe operably positioned on front leg 26, preferably in proximity to rear leg 34, for example, on bottom surface 41, of end portion 40, of front leg 26, as seen in FIG. 5. Of course, other types of light source may be used if desired, such as fiber optics, LED, or other illumination means well known in the art. The light source may also be located in other positions on base 12, for example, in different positions on front leg 26, front leg support 30, or rear leg 34.

As seen, in FIGS. 1 and 4, base 12, preferably includes a rear leg element 34, which may include slots 36 for holding additional credit cards, debit cards, receipts or the like. A pair of receptacles 38, for pens 39, may be provided for support and stability are preferably positioned in proximity to rear leg 34, as shown.

Base 12, in the preferred embodiment, is composed of polystyrene, however, other durable resilient materials may be used, such as plastics, thermoplastics, metal, wood, or the like.

In operation and use, holding and display device 10, is very easy to use, efficient, and reliable, for securing and positioning items such as credit cards, debit cards, receipts, business cards, or other items for view. Holding and display device 10, may be provided with illumination means 31, such as a light bulb, LED, fiber optics or the like, for use in dark areas such as bars and restaurants. Holding and display device 10, is preferably molded with receiving aperture 24 for lens element 14, and may be provided with a hollowed out underside 13, to make it lighter and to facilitate stacking.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

1. A device for holding, magnifying, and displaying credit cards, debit cards, and other articles, comprising:
a lens element, said lens element having one or more receiving slots for holding, securing, and displaying credit cards, debit cards, or other articles, and;
a base, said base having a receiving aperture for receiving and securing said lens element therein.

2. The device of claim 1, wherein said base is substantially rectangular in configuration.

3. The device of claim 1, wherein said base further includes a front leg element.

4. The device of claim 3, wherein said front leg element further includes a plurality of holes.

5. The device of claim 1, wherein said base further includes a rear leg element.

6. The device of claim 5, wherein said rear leg element has a plurality of receiving slots therein for holding and positioning credit cards, debit cards, or other articles therein.

7. The device of claim 1, wherein said lens is curved.

8. The device of claim 1, wherein said lens is flat.

9. The device of claim 1, further including illumination means for illuminating said lens element in which credit cards, debit cards, or other items are held in the device.

10. The device of claim 9, wherein said illumination means is a light operably positioned in said base.

11. The device of claim 1, wherein said base is composed of plastic.

12. A portable device for holding and displaying credit cards, debit cards, and other articles, comprising:
a lens element, said lens element having one or more receiving slots in a bottom surface, for holding, securing, and displaying credit cards, debit cards, or other articles, allowing for the;
a base, said base having a receiving aperture for receiving and securing said lens element therein.

13. The device of claim 12, wherein said base is substantially rectangular in configuration.

14. The device of claim 12, wherein said base further includes a front leg element.

15. The device of claim 4, wherein said front leg element further includes a plurality of holes.

16. The device of claim 12, wherein said base further includes a rear leg element.

17. The device of claim 16, wherein said rear leg element has a plurality of receiving slots therein for holding and positioning credit cards, debit cards, or other articles therein.

18. The device of claim 12, wherein said lens is curved.

19. The device of claim 1, further including illumination means for illuminating credit cards, debit cards, or other items held in the device.
